(19) United States
(12) Patent Application Publication
(10) Pub. No.: US 2002/0087412 A1
(43) Pub. Date: Jul. 4, 2002

(54) Method for post-sales customer retention

(76) Inventor: Fay Wood, Huntington Beach, CA (US)

Correspondence Address: RIORDAN & MCKINZIE, 300 SOUTH GRAND AVENUE, 29TH FLOOR, LOS ANGELES, CA, 90071, US

(21) Appl. No.: 10/033,298

(22) Filed: Oct. 24, 2001

Related U.S. Application Data
(60) Provisional application No. 60/242,824, filed on Oct. 24, 2000.

(51) Int. Cl. G06F 17/60

(52) U.S. Cl. 705/15

(57) ABSTRACT

A method for post-sales customer retention offers merchants an effective means by which to retain customers while providing customers with a simple, centralized service whereby they can keep track of their product purchases and information pertaining to such purchases, such as warranty information and repair history of products. A service according to one embodiment of the present invention offers merchants a centralized customer product information service. The centralized product information service comprises a collection of customer databases. The service further provides access to these customer databases to the merchants' customers.

### PRIORITY CLAIM

This application claims priority to the filing date of U.S. Provisional Patent Application Serial No. 60/242,824 filed on Oct. 24, 2000.

### BACKGROUND OF THE INVENTION

1. Field of the Invention

The present invention relates generally to the field of post-sales online customer service and support, and more specifically to a method for post-sales customer retention.

2. Description of the Prior Art

Internet commerce is transforming the global retail arena, altering businesses of all shapes and sizes. Online retailers have only a limited opportunity to establish their position in the online marketplace, and that window is closing quickly. According to International Data Corporation Research, Inc. (“IDC”) research, the U.S. share of Internet commerce will plunge from 62% in 1999 to 48% in 2001. As the market becomes increasingly saturated, the landscape is shifting from a multitude of idea-and momentum-based start-ups to a small number of solid businesses with a proven, profitable and sustainable business model. These companies compete in an environment that is changing faster than it can establish roots. Yesterday's objectives were to create a cutting-edge website, generate massive site traffic, and produce a stunning initial public offering. Today's challenge is to convince customers to return to the site in order to survive.

The sheer volume of online options allows today's increasingly sophisticated consumers to demand superior shopping experiences, with expectations of competitive pricing, streamlined and secure site navigation, non-obtrusive customer communications, and flawless customer service. To ensure customers make that critical first purchase and are satisfied enough to return, savvy retailers are continually adapting their practices and offerings to meet these demands, as well as anticipating future consumer expectations ahead of the competition. These same companies are now realizing a neglected facet of their customers' online shopping experience—services and support beyond the purchase—and are quickly moving to take advantage of the enormous relationship-building opportunity it represents.

Post-sale customer retention solutions are consistently utilized and proven effective in the brick & mortar world, yet the challenge lies in creating effective strategies for the virtual, anonymous environment of the Internet. If you cannot greet your customers with a smile, how can you generate lasting customer relationships and loyalties? As an industry in its infancy, the priorities of online retailers have always been on customer acquisition: generating website visitor volume and creating brand awareness. Luring customers to a website is a difficult and expensive undertaking, and online retailers have found themselves spending often exorbitant amounts of money on marketing, public relations and advertising campaigns, while receiving only modest results.

Forrester Research has determined that Internet retailers on average spend a whopping 75% of their online promotions budgets on customer acquisition tactics. Yet it is estimated that as many as 98.7 percent of consumers who visit a site do not return, even if they do make a purchase. Between feeble look-to-buy conversion rates, abandoned shopping carts, and a lack of customer loyalty, it is no wonder many Internet retailers have been fiercely criticized for careless customer acquisition spending habits.

According to an IDC Research study, it is five times more expensive to acquire a new customer than to retain a current one. Successful online retailers recognize the power of customer loyalty, measured in repeat purchases and referrals, as the key driver of profitability of online businesses—even more so than for offline companies. Not surprisingly, it is an escalating trend by interested investors and partners to gauge a business by its customer retention value (“CRV”) when evaluating a company. Whereas customer acquisition represents the largest cost for the least return on investment, effective customer retention seals the future stability of the business. A million-dollar advertising campaign may attract quite a few visitors and/or customers, but if the company's customers are dissatisfied or indifferent once they've made a purchase, it is not likely that they will return.

The benefits of customer retention are indicative of a tremendous, untapped marketing opportunity for all online businesses—and in the future's quickly consolidating marketplace, an opportunity too critical to ignore. At the heart of any retention solution are relationship building products and services. The extent of current online retention strategies is usually various email communications with customers, such as post-sale appreciation letters, surveys, newsletters, updates, or promotional offers. A recent Forrester Research report estimates that e-businesses will send 80 billion retention-based emails in 2002. While the intent is right and the volume may generate results, customer retention must move beyond this initial strategy to encompass the full range of product lifecycle services and support in order to be effective in the future economy.

In contrast to email-based retention strategies, the future of online customer retention lies in broad and comprehensive solutions. Partial programs and offerings will be insufficient in tomorrow's fiercely competitive landscape, as fewer companies vie for customer loyalties. As rapidly as e-businesses are proliferating, user expectations are evolving, marketing and budget priorities are changing, and competitors are battling as never before for customer loyalties to their brand. We are leaving the era of quantity, measured by site visits and pricey advertising campaigns, and quality is emerging as the new priority in successful business practices. Shifting priorities from aggressive customer acquisition strategies to a more effective retention-based model is now recognized as an essential step toward ensuring the future security of an e-business.

Retention-based products and solutions enhance profit margins and customer lifetime values for online retailers by:

Generating customer loyalty. Effective retention solutions cement the customer-merchant relationship, enabling retailers to win their customer' trust and long-term business. Loyal online customers, like their offline equivalents, spend more, refer more people and are willing to expand their purchasing into new categories;

Improving sales conversion rates. Shopping cart abandonment and critically low sales conversion rates are major obstacles to economic success in the online marketplace. Market analysis firm Datamonitor estimates that, unless these issues are resolved, the market could suffer a cumulative loss of more than $173 billion in potentially salvageable sales over the next five years. Explanations for these problems include customer dissatisfaction, confusion, uncertainty or estrangement—all of which can be alleviated by developing customer trust and loyalty;

Recovering customer acquisition investment. In most cases, a customer needs to shop at a site multiple times before he or she becomes profitable to the online retailer. Web-based retention programs are designed to bring customers back to the site again and again;

Averting future customer acquisition costs. Establishing relationships with customers now will help alleviate the sharply escalating expense of customer acquisition tactics in the future;

Securing competitive advantage. In an increasingly crowded marketplace, a retention program enables online businesses to differentiate their value-added offerings from would-be competitors. Early movers implementing retention solutions have the added advantage of solidifying customer loyalties first;

Increasing revenue. Studies by Bain & Co. and Mainspring confirm that the more often a customer visits a site, the more likely that customer will spend an increasing amount of money and generate more profits for the online retailer.

The benefits of customer retention are indicative of a tremendous, untapped marketing opportunity for all online businesses—and in the future's quickly consolidating marketplace, an opportunity too critical to ignore. By providing a whole new scope of value-added services, an effective retention program increases a customer's interaction with the retailer, fulfills new customer needs, and leads the customer to the website again and again. The resulting relationships, loyalties, and profit margins may prove to be both the defining factor and a company's best defense in the imminent, survival-of-the-fittest dot com shakedown.

### SUMMARY OF THE INVENTION

The present invention discloses a method for post-sales customer retention. The present invention offers merchants an effective means by which to retain customers while providing customers with a simple, centralized service whereby they can keep track of their product purchases and information pertaining to such purchases, such as warranty information and repair history of products. A service according to one embodiment of the present invention offers merchants a centralized customer product information service. The centralized product information service comprises a collection of customer databases. The service further provides access to these customer databases to the merchants' customers.

### BRIEF DESCRIPTION OF THE DRAWINGS

The present invention is illustrated by way of example and not limited in the following drawings, in which like references indicate similar elements, and in which:

FIG. 1 illustrates an overview of the various services that may be offered according to one embodiment of the present invention.

### DETAILED DESCRIPTION OF THE INVENTION

The present invention discloses a method for post-sales customer retention. In the following description for the purposes of explanation, numerous specific details are set forth in order to provide a thorough understanding of the present invention. It will be evident, however, to one skilled in the art, that the present invention may be practiced without these specific details. In other instances, detailed descriptions of well-known methods and devices are omitted so as not to obscure the description of the present invention with unnecessary detail.

Glossary

The following definitions are provided to facilitate understanding of certain terms used frequently herein.

E-Merchant—Synonymous with e-Business and e-Tailers. Refers to Merchants with an Internet presence retailing products online.

E-Service Infrastructure Platform—A platform that enables e-Businesses to offer a variety of post-sale, value added services to their customers. It provides and manages all the software and services required for tight integration and control of a complete customer retention program.

Extended Support and/or Service Plan—Extended support and/or service plans are contracts by an insurer to pay for service that is needed for a specified time beyond the manufacturer warranty.

Point-of-Sale Transactions—When referring to contracts, indicates that a contract was sold when the product was purchased from the e-Business site. For example, if a TV is purchased from Buy.com and the extended support plan they offer for the TV is also bought, the contract is purchased at the point of sale.

Contract Catalog—In Business Central, the Contract Catalog refers to the collection of selected contract programs and individual contracts the Merchant chooses to offer on their site. The Merchant may customize its contract catalog based on product class, category and subcategory.

Product Support Central Integration—Integration details for Merchants.

Service Alliance—a network comprising members who contract for repair services at a predetermined rate.

Service Provider—Synonymous with a Service Center.

Class—An object-orientated programming term that defines the implementation of objects that can inherit or share certain characteristics. In Java, all program behavior is defined by classes descending from the object class. A class is like a blueprint for creating objects; just as more than one building can be created from a blueprint, more than one object may be created from a class.

Co-location—Most often used to refer to having a server that belongs to one person or group physically located on an Internet-connected network that belongs to another person or group. Usually this is done because the server owner wants his/her machine to be on a high-speed Internet connection and/or he/she does not want the security risks of having the server on their own network.

HTML (HyperText Markup Language)—The coding language used to create Hypertext documents for use on the World Wide Web. HTML looks a lot like old-fashioned typesetting code, where a block of text is surrounded with codes that indicate how it should appear. Additionally, in HTML, a block of text, or a word, can be linked to another file on the Internet. HTML files are meant to be viewed using a World Wide Web Client or Browser Program, such as Netscape Navigator or Microsoft's Internet Explorer.

HTTP (HyperText Transfer Protocol)—The protocol for moving hypertext files across the Internet. Requires a HTTP client program on one end, and an HTTP server program on the other end.

Java—An object-oriented programming language for portable, interpretive code that supports interaction among remote objects. Java was developed and specified by Sun Microsystems, Incorporated (“Sun”). The Java environment consists of the JavaOS, the Virtual Machines for various platforms, the object-oriented Java programming language, and several class libraries.

Multi-tiered architecture—This is the most scalable application architecture (over 2-tier and 3-tier). This architecture refers to 4-, 5-, or even higher-tiered architectures. It is the most complex type of architecture, splitting the application and database management tasks into many discrete components. For example, 3-tier architecture may be changed so that the application logic is separate from the database management system. This then becomes 4-tier architecture. With this structure, one of the tiers can be more easily changed without compromising the entire application. To get to five tiers, some of the application logic could be moved to the client to optimize performance.

Scalable—This adjective describes applications or systems that are able to scale to large numbers of users. For example, a database that completely locks out every other user when someone is using it is NOT scalable. The computer system that runs ATM and bank transactions must be highly scalable.

N-tier—Some number of tiers (servers, layers, elements, etc.). See definition of “multi-tier.”

Java Server Pages (JSP)—A freely available specification for extending the Java Servlet API to generate dynamic web pages on a web server. The JSP specification was written by industry leaders as part of the Java development program. JSP assists developers in creating HTML or XML pages that combine static (fixed) page templates with dynamic content. Separating the user interface from content generation allows page designers to change the page layout without having to rewrite program code. JSP was designed to be simpler than pure servlets or CGI scripting.

Mission Critical—Vital to the operation of an organization. In the past, mission critical information systems were implemented on mainframes and minicomputers. Increasingly, they are being designed for, and installed on, personal computer networks.

Enterprise Java Beans (EJB)—A component software architecture from Sun that is used to build Java applications that run in the server. It uses a “container” layer that provides common functions such as security and transaction support and delivers a consistent interface to the applications regardless of the type of server. CORBA is the infrastructure for EJBs, and at the wire level or transport layer, EJBs look like CORBA components. EJBs are the backbone of Sun's J2EE platform, which provides a pure Java environment for developing and running Web-based applications.

Oracle 8i—A version of the Oracle DBMS that includes Internet enhancements. Introduced in 1999, noteworthy features are increased performance and support for XML and Java. A JVM (Java interpreter) is built into the DBMS so that triggers and stored procedures can be written and executed in Java rather than PL/SQL. It enables Internet developers to write applications and database procedures in the same language. In addition, the JVM can also execute EJBs, turning the DBMS into an application server.

Load Balancing—The fine tuning of a computer system, network or disk subsystem in order to more evenly distribute the data and/or processing across available resources. For example, in clustering, load balancing might distribute the incoming transactions evenly to all servers, or it might redirect them to the next available server.

UML (Unified Modeling Language)—An object-oriented analysis and design language from the Object Management Group (OMG). Many design methodologies for describing object-oriented systems were developed in the late 1980s. UML standardizes several diagramming methods, including Grady Booch's work at Rational Software, Rumbaugh's Object Modeling Technique and Ivar Jacobson's work on use cases. There are nine kinds of diagrams that are supported under LTML.

Business Objects—A broad category of business processes that are modeled as objects. A business object can be as large as an entire order processing system or a small process within an information system.

Heterogeneous Environment—Using hardware and system software from different vendors. Organizations often use computers, operating systems and databases from a variety of vendors.

Open Systems—Open systems includes database management systems (DBMSs) that run on many different platforms as well and any other tools that are used across multiple platforms. While this provides a certain freedom for future changes, it is by no means a problem free environment and never will be. Whenever several hardware platforms are used, a version of each software product must be available for that platform.

J2EE (Java 2 platform, Enterprise Edition)—A platform from Sun for building Web-based enterprise applications. J2EE services are performed in the middle tier between the user's browser and the enterprise's databases and legacy information systems. J2EE comprises a specification, reference implementation and set of testing suites. Its core components are EJBs, followed by JavaServer Pages (JSPs) and Java servlets and a variety of interfaces for linking to the information resources in the enterprise.

Servlet—A Java application that runs in a Web server or application server and provides server-side processing, typically to access a database or perform e-commerce processing. It is a Java-based replacement for CGI scripts, Active Server Pages (ASPs) and proprietary plug-ins written in C and C++ for specific Web servers (ISAPI, NSAPI). Because they are written in Java, servlets are portable between servers and operating systems. The servlet programming interface (Java Servlet API) is a standard part of J2EE. If a Web server, such as Microsoft's Internet Information Server (IIS), does not run servlets natively, a third-party servlet plug-in can be installed to add the runtime support.

Triple-Redundant—Three systems that are completely identical to each other. Two of the systems are commonly located in one location while the third system is typically geographically separated.

Sun 420R platform—The Sun Enterprise™ 420R server is a four processor workgroup server for network computing based on the UltraSPARC™ processor technology. This workgroup server brings multiprocessing power, UltraSCSI disks, and the industry-standard peripheral component interconnect (PCI) I/O bus to a highly modular, rack optimized 4RU (rack unit) design. The Sun Enterprise 420R server gives customers the flexibility to scale their processing needs without wasting precious space, making it an ideal server for service providers, financial institutions, computing-intensive environments, or anyone who needs strong processing power in a small footprint.

Dual-mounted D1000 storage arrays—The Sun DI1000 systems offer a high-performance and truly versatile storage solution. These expandable RAID systems allow for customizing storage environments, offering superior performance and availability as a stand-alone device, or increased storage capacity as a rack-mounted solution.

Servlet Chaining—Servlet chaining is the ability for one servlet's output to be ‘piped’ in to the input of another servlet. This can continue for multiple servlets. This simple yet powerful notion means that different servlets, perhaps from different vendors, can work together seamlessly.

Servlet Zones—The cluster is logically partitioned into servlet zones where each zone represents a virtual servlet engine and all the servlets that it hosts (i.e., each zone has its own servlet repository). All servlets within a zone typically share a common logical context and represent an application.

Servlet Clustering—Multiple copies of the servlet engine can be distributed/replicated across one or more machines. The collection of distributed servlet engines is referred to as a Servlet Engine cluster. The Web server distributes the HTTP request load (servlet requests) across the Servlet Engine cluster.

Redundancy—The capability of a computer system to shrug off the failure of a device and continue operating normally. Redundancy is often implemented by simply adding a second device (e.g. a second hard drive or a network card).

Live-Object Cache—Live object cache maps information from the relational tables of the Oracle 8i database into business objects and stores this information in memory, not on disk.

Design Cycle Process—An object-oriented analysis and design methodology that supports an interactive design model necessary in developing complex software.

Application Architect—An individual who responds to business and technical requirements through planning, acquisition, and definition of the systems architecture and infrastructure necessary to create and sustain the company's technological advantage over its competitors worldwide.

Detailed Description

The present invention presents a comprehensive solution to the previously described issues pertaining to post-sales customer retention. A successful retention program may include any combination of the following value-added, post-sale services, all of which are designed to generate customer frequency and solidify loyalties by increasing customer-retailer interaction opportunities.

1. Personalized Customer Communications. The focus with retention communications remains on the customer. Promotion of sales opportunities is important, but must be presented to customers in a personalized, valuable format to be effective. By maintaining a non-imposing, interactive dialogue with the customer, retailers create a permission-based customer relationship and provide value in every email message sent.

In addition to standard customer appreciation or sales notifications, communications may include courtesy notices of product warranty expirations, ESP enhancements, or product upgrades. The product repair cycle also presents an ideal opportunity for customer interaction, allowing the retailer to remain involved in every step of the service cycle.

2. Product Resources, Tools & Information. Like a product medicine cabinet, the retention solution can encompass anything and everything a customer might need in the post-sale cycle. These value-added services are simple to implement and provide important customer frequency opportunities—customers come to rely upon a site's resources, establishing an invested interest in the retailer. From online product manuals to serial number records, customers quickly become dependent upon this type of service, which enables them to do the following:

Encourage customers to manage information relating to their purchases, such as product specifications, serial numbers, receipts, and purchase dates from your website.

A warranty portfolio allows customers to similarly manage warranty and ESP information, such as coverage, terms and conditions, expiration dates, and ESP details and purchase options, taking the uncertainty out of the often-confusing warranty process.

Online product guides, buyer's guides, Frequently Asked Questions (“FAQs”), and Installation tips.

Access to often hard-to-find manufacturer phone numbers, emails, websites, and addresses, and direct lines to customer support.

3. Consolidated Product Repair Services

Retailers often lose customers to other points of contact throughout the post-sale cycle—with each call to the product manufacturer's technical support, the contracted warranty service provider, or a product repair center—and these opportunities are potentially a premium asset to online retailers. By aggregating these contact points into a single location, on the retailer's website for example, it creates benefits for all parties: customers are appreciative of the timesaving value, and retailers enjoy an integrated relationship with their customers.

Such product repair services may include:

Electronic repair service platform, enabling customers to locate servicers, book repair appointments online, and track the repair process.

Online records of repair service history and status.

Customer care center for inquiries, information, and technical or customer support.

Troubleshooting and self-diagnosis web-based guides.

4. Online Service Contracts

Perhaps the most tangible post-sale retention component to any retail company is the service contract offering. Warranties, ESPs and replacement programs can account for as much as 30% of a traditional retailer's revenue base. In fact, Forrester Research reports that in 1998, service contracts for consumer electronic products alone generated over $5 billion in revenue.

In the e-commerce arena, electronic service contracts represent a pure relationship-building opportunity to increase customer lifetime value by enhancing the quality of the customer-merchant relationship. In effect, online service contracts uncover a new segment of customer needs to fulfill, acting as a trigger for online businesses to initiate the customer retention process.

Forrester Research expects the online extended service provider market to grow to more than $107 billion by 2002, representing a tremendous market potential for this common retention solution. The online platform enables the registration of warranties and extended service plans beyond the point-of-purchase sale, which differentiates it from traditional retail ESP models. With warranty plan information and purchase options always readily available on the retailer's website, customers no longer need to feel pressured in their warranty decisions.

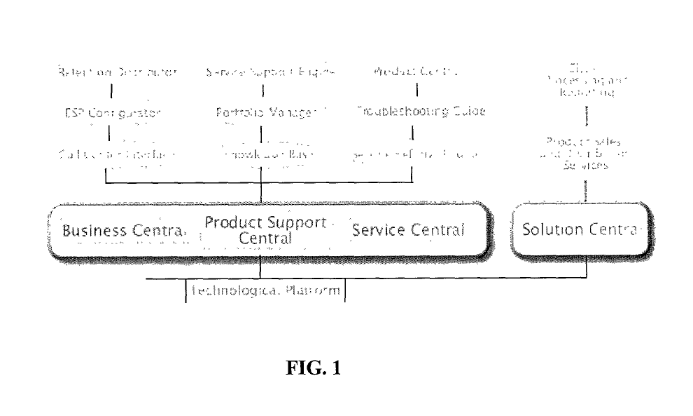

The present invention is a comprehensive solution that encompasses various post-sales customer retention solutions. FIG. 1 illustrates an overview of the various services that may be offered according to one embodiment of the present invention. These services include an e-Service Infrastructure platform that enables e-Busine to offer a variety of point-of-sale and post-sale, value-added services to their customers, such as ESPs, online repair arrangement and repair status tracking, extensive product and manufacturer information and personalized product lifecycle management tools.

One embodiment of the present invention links e-Businesses, customers, and service providers. It provides and manages all the software and services required for tight integration and control of a complete customer retention program. According to this embodiment, e-Businesses can increase their profit margins, point-of-sale transaction volumes, and customer lifetime values.

The present invention additionally provides e-Businesses with, quick, online registration, dynamic ESP contract catalog selection, generation, and distribution, simple, flexible Web site integration, branded customer interaction, and flexible tools for ongoing management of the customer retention program. E-Businesses' customers benefit from enhanced customer service, improved product protection, online access to qualified service centers, online repair arrangement and status tracking, extensive product and manufacturer information and online product lifecycle management tools.

According to one embodiment, the e-Service Infrastructure platform of the present invention includes, but is not limited to, the following components: “Product Support Central,” “Business Central,” and “Service Central.” The e-Service Infrastructure platform may be offered by any number of third parties, such as SatisFusion, Inc. The following describes in further detail the functionality of each of the above components.

A. Product Support Central

The Product Support Central Component of the present invention provides merchant customers with state of the art customer service life cycle management of their purchased product. Product Support Central is a source of product and service information that ensures increased customer satisfaction along with increased sales. Customers access Product Support Central through a transparent B2B2C integration—Product Support operates within the online seller's shopping environment. Customers can access the necessary services and add-on products to maintain and enhance their product purchases through a consistent shopping experience.

According to one embodiment of the present invention, Product Support Central comprises of a Portfolio Manager, an ESP Sales Manager, a Library Manager, and/or a FAQ Manager. The Portfolio Management Application allows consumers to view product and contract information, view product documentation, view manufacturer warranty and contact information, and arrange and track service of their products. Product Support Central also lets users of the system manage, edit and modify the collection of products in their Product Portfolio. For example, consumers of electronics can view and edit details about products they have purchased from online merchants, including warranty support information and expiration dates, and registered users of the site can view electronic documentation about consumer electronics they have purchased such as hook-up diagrams, user's guides, and installation manuals. Consumers may use this module to request service for a product they own under warranty.

Integration of Product Support Central into a Merchant's operations is straightforward and quick to implement, consisting of HTML integration and seamless data transfer. Merchants integrate Product Support Central for their customers by adding a simple link from the Merchant's site to the Product Support Central application at the third party site. Customers are not required to go through a separate login process to access Product Support Central from the merchants site and the customer entrance to the Warranty Center can be customized to suit the merchant's environment. Product Support Central has been designed to load seamlessly within a web page on the Merchant's site. It may also be loaded as a separate page hosted on any third party website. Merchant specific parameters coded into the link provide Product Support Central with all the data required to launch a personalized Product Support Central session for a given customer. Populating the customer's purchase into Product Support Central is done through a seamless data transfer process.

The following summarizes the various services offered by Product Support Central:

| | |
|---|---|
| Portfolio Manager | Merchants may continue to draw customers back to their site to access the |
| | wealth of information at Product Support Central. Each visit represents |
| | another sales opportunity. Through Product Support Central, customers can |
| | view their online personal portfolio, listing all the products they have |
| | purchased from the merchant as well as all products that they have |
| | registered in their portfolio. The portfolio includes purchase information, |
| | product specifications and manuals, warranty coverage, and product |
| | documentation and tracking. The personalized product portfolio replaces |
| | the folders and product information tracking that customers have at home. |
| Service Support | Product Support Central links customers with an extensive network of |
| Engine | qualified service providers. For those occasions when a product fails, |
| | Product Support Central helps customers locate a convenient, authorized |
| | service center capable of providing the required repairs. Customers may |
| | even receive driving instructions and maps to the service location. Product |
| | Support Central enables online repair arrangement, tracking and status |
| | updates, reducing traffic to merchant call centers for repair status inquiries, |
| | while providing 24/7 access to customers. Customers may track the status |
| | of their product repair, and receive daily updates and completion estimates. |
| | An e-mail notification is sent to customers upon completion of repairs. The |
| | Service Support Engine may turn product failure into a positive customer |
| | service experience. |
| Product Library | Customers may have access to on-line product manuals, installation guides |
| | and hook up diagrams. Through Product Support Central's Product |
| | Library, customers may have immediate access to all Product Information |
| | needed to set up, program, manage or install their products. Customers no |
| | longer have to fumble through their drawers and cabinets to find these |
| | documents they will return directly to your site. |
| Troubleshooting | Information empowers customers to correct common problems on their |
| Guide | own, decreasing down time, increasing customer satisfaction and reducing |
| | unnecessary product repairs. Through the Troubleshooting Guides, |
| | customers may identify and correct common problems on their own, |
| | reducing product down time increasing customer satisfaction levels. |
| | Customer retention may be achieved by ensuring educated, satisfied |
| | customers. |
| Retention | Part of customer satisfaction and retention is providing informative education |
| Distributor | products and service communication. Product Support Central automatically |
| | notifies customers of product warranty status, service updates and ESP |
| | expirations. Event-driven applications send customers merchant-branded e-m |
| | encouraging repeat visits to the merchant's site. |
| ESP Integration | Product Support Central enables merchants to capitalize on missed sales |
| | opportunities by supplying customers with continuous opportunities to |
| | purchase an ESP throughout a product's manufacturer warranty. |

B. Business Central

Business Central is a complete contract program management module that empowers Merchants to customize their contract catalog, generate contract reports, and provide customer support. Business Central also provides Merchants with Product Support Central Integration assistance. Merchants can configure the system to only support their specific product offering, such as only a particular type or duration of extended warranty. Business Central supports the on-line customization and management of Product Support Central and ESP products. Business Central enables a merchant to integrate and manage the eService product, providing customers with on-line product life cycle support and customer service. Business Central also enables a merchant to develop, customize and launch an ESP program. Signing up and integrating the Product Support Central component of the present invention with Business Central is hassle free. Through on-line registration, merchants can sign up and begin providing customer and product service solutions. The Online Registration procedure allows merchants to sign up to immediately provide post-sales support and services to their customers.

Merchants have significant flexibility in determining and controlling their Product Support Central and Business Central. An “identity processor” enables a merchant to customize the customer log on and service experience. Merchants may select various levels of customization. Smaller merchants with less expertise may customize by using predefined templates, while advanced and expert users may be allowed to modify templates and/or specify fonts, colors and other such details. An “integration engine” provides on-line integration management, support, status and tools to provide a seamless on-line integration experience. Together, the identity processor and integration engine enable the merchant to customize Product Support Central and Business Central for each customer, thus making integration to these services transparent to their consumers. Merchants may also offer to customer their ESP offering through the ESP Configurator (see below). The following summarizes the various services offered by Business Central:

| | |
|---|---|
| eService Manager | Merchants may implement and manage the customer service and product |
| | support solutions provided through eService. Through Business Central, |
| | merchants can obtain integration services and support, integrate service and |
| | product support into existing call center services and upload customer product |
| | portfolio information. |
| Retention | Business Central provides a web based reporting engine for merchants to run |
| Reporting | and view reports on-line. Retention reporting provides analysis on ESP |
| | attachment rates, 2^{nd} effort ESP sales and overall profit margins from the ESP |
| | product. |
| ESP Configurator | Merchants may immediately modify and enhance their ESP catalog to support |
| | and match new product offerings, so they do not miss out on any potential sales. |
| | The Merchant Center provides real time access to current ESP contract |
| | offerings. Merchants can also review and track all contract catalog updates, |
| | transmissions and modifications. The iXchange Hub ™ translates the catalog |
| | from Product Support Central or Business Central's native format to the |
| | merchant's preferred format for file transfer. |
| 24 × 7 Customer | Customer loyalty is fortified by excellent service. Merchant support staff may |
| Support | satisfy customers more effectively with real time access to their relationship |
| | history. Through the Merchant Center, authorized staff may view customer |
| | profiles and purchase and repair service histories. |
| On-line Report | Real time, online access to sales trends and statistics enhances merchants' |
| Engine | customer retention knowledge and management ability. The Merchant Center |
| | supports online report generation and viewing capabilities. Merchants may |
| | specify desired report formats. For example, sales can be reported by class, by |
| | category, or by month. |
| Implementation | The easy to use Merchant Center web application minimizes the time required to |
| Support | manage the customer retention program. The Merchant Center supports user- |
| | friendly account profile and security management. Authorized users may add, |
| | view, and modify the security access to the Merchant Center for individual |
| | users. Authorized users may also modify the time and frequency of file transfers |
| | between eRetentions and the merchant. |
| Online | Online merchants may have a customized retention management program up and |
| Registration | running in hours-immediately increasing sales opportunities. The registration |
| | procedure sets up a unique account and profile for each merchant. The merchant |
| | may then select extended service offerings from Business Central's master |
| | catalog to match their particular product offering. Business Central |
| | automatically generates and deploys an ESP contract catalog to the merchant. |

C. Service Central

Service Central is an online referral application Service Alliance networks, supporting the service provider community. This application registers membership information into the Service Alliance offering. Once approved, the Service Provider may use the referral program contained within this module to manage repair referrals received when a consumer arranges service through Product Support Central. This application may be used, for example, by vendors who wish to offer extended warranties and repair services, but who do not wish to maintain a repair center. Such a vendor may instead register with a network, pay the network a predetermined repair fee and the network will then provide repair services to the vendor's customers.

Service Central is an integral component of the present invention, equipping authorized service providers with tools to generate new business and integrating customers and servicer centers together on-line. Service Central supports online, user-friendly service provider registration, real time repair request notification, repair status tracking, and access to the eRetentions knowledge base.

Service Central enables merchants to offer a real time, on-line service support engine to their customers. Through Service Central, service providers may provide real time service, completion estimate, service updates and completion notification. Product Support Central, which is seamlessly integrated with Service Center provides customers with repair arrangement, on-line service tracking and updates on their product all on-line at their fingertips.

The following is a summary of services offered by Service Central:

| | |
|---|---|
| Service Support | Service providers are immediately exposed to the market reach of the entire |
| Engine | eRetentions network. Service providers may experience increased repair leads |
| | and revenues. Integration with Product Support Central |
| Referral Engine | The online network delivers service request notifications in real time enabling |
| | prompt service and customer satisfaction. |
| Repair Tracker | 24/7 access to crucial information optimizes efficiency. Authorized service |
| | providers gain access to the eRetentions knowledge base, including product |
| | schematics and service tips. Accurate customer, product and warranty coverage |
| | information is guaranteed. Service providers can also join eRetentions' service |
| | center network to share best practices to improve productivity. |
| On-line | Service provider efficiency in managing repairs from initial request through to |
| Registration | completion is enhanced with real time repair status tracking. Product Service |
| | Central's automated repair tracking and maintenance application software is |
| | available through the Service Center. |
| Seamless Claim | |
| Processing | |

According to one embodiment, the present invention is implemented as an n-tier application that is separated into three layers: the presentation tier, the business tier, and the data tier. In one embodiment, the presentation tier may be implemented using HTML generated by Java Server Pages, the business tier may be implemented using a combination of Server Side Java Classes and EJBs, and the data tier may be implemented using Oracle 8i. Alternate implementations may also be utilized without departing from the spirit of the present invention.

Superior Performance EJBs may be used to create a fully modular software architecture that can be managed and chained to associate and allocate all components according to specific performance criteria. This supports the present invention's ability to execute many requests in parallel within a fewer number of processes rather than creating a new process for each HTTP request. This feature provides automated load balancing to ensure that all users receive superior performance consistently.

Servlet clustering allows multiple copies of the servlet engine to be distributed as the Application Architect determines. This enhances the application's ability to be logically partitioned based upon expected performance demands by service type. Logically partitioning an application in this manner is referred to as creating servlet zones. Each servlet zone represents a virtual engine within the application's architecture.

The development environment consists of many independent (yet interoperable) Internet-enabled tools, including:

i) A “best practices” requirements tool generates the initial business model input. “Best practices” refers to a proven industry practice that facilitates quality products.

ii) A UML business-modeling tool supports the Business Analysts efforts to fine-tune the graphical representation of the business process.

iii) An enterprise-class application server generation tool accepts its input from the business-modeling tool by translating the business process into a framework understood by Java.

The output from the application server generation tool enables any browser to instantly access the automatically generated EJBs. The automatically generated EJB framework efficiently and reliably supports high transaction volumes characteristic of e-Business applications. The development environment according to one embodiment of the present invention provides an automated, complete and secure end-to-end infrastructure solution that is not labor-intensive to build, expand, or maintain.

The infrastructure solution may support the distribution at will of any EJB component. This creates numerous, valuable options for the Application Architect to reconfigure, load-balance, or create redundancy at any point in the application system. The generated framework leverages the functionality of a live-object cache. A live-object cache may map information from the relational tables of the Oracle 8i database into business objects and stores this information in memory, not on disk. Accessing these business objects in memory is much faster than accessing them from disk (to about three orders of magnitude faster).

According to one embodiment, the present invention is J2EE compliant. Development may be performed using a Java-based object oriented methodology and coded with Java and EJB technology. EJB technology is an extension of Java that integrates Internet technology, distributed object architecture and platform-independent coding. Using EJB enables applications to communicate across multi-tiered client and server environments. The portability of EJB is enabled through the use of standard Java application programming interfaces (APIs). The Enterprise Java APIs were developed by Sun with input from industry leaders such as IBM, HP, Compaq/Tandem, Oracle, Sybase, Informix, and Novell. While the above description focuses on EJB, it will be apparent to one of ordinary skill in the art that similar functionality may be achieved with other comparable implementations.

The “Write Once, Run Anywhere” portability of Java and EJB mean they are platform independent. Because the present invention is J2EE compliant, it may be implemented within a multi-vendor, heterogeneous environment. Because of its inherent scalability, as system demand increases, the increased workload can be distributed across larger or additional servers.

EJB technology provides for transaction management, security, persistence of data and the life cycle management of objects. The present invention thus frees developers to concentrate on the unique business issues and logic of the application, speeding development time. EJB technology's modular approach and reusability of components, together with an iterative design cycle process, strengthens the present invention's ability to rapidly develop and deploy application enhancements.

The present invention supports a seamless integration of various components. Merchants may have considerable flexibility in determining and controlling how they choose to integrate Product Support Central into their shopping environment. The integration process is simple. It may be accomplished almost entirely through the web browser without any additional downloads, plug-ins, or special protocols. The integration process may work as follows:

1) The merchant selects the contracts online;

2) Third party (e.g., SatisFusion) sends the ‘inventory’ of contracts, via file, to the merchant; and

3) The merchant's information technology staff integrates the contracts into its e-commerce program.

All merchants with web browsers thus have the ability to integrate the components of the present invention. Browser requirements are minimal because client-side validation is used. Cookies and client-side Java are not required, but Javascript is required to perform the client-side data-entry validation routines.

The integration component where the merchant's website redirects the consumer to the third party site hosting the components of the present invention is extremely simple: the merchant merely has to redirect the browser via a standard HTTP request to the third party website, passing the appropriate parameters as outlined in the integration kit that the third party provides to the merchant.

Thus, a method for post-sales customer retention is disclosed. Although the present invention has been described with reference to specific exemplary embodiments, it will be evident to those skilled in the art that various changes and modifications may be made to these embodiments, and equivalents may be substituted for elements in these embodiments, without departing from the general spirit and scope of the invention. In addition, many modifications may be made to adapt a particular element, technique or implementation to the teachings of the present invention without departing from the central scope of the invention. Accordingly, the specification should be regarded in an illustrative rather than a restrictive sense.

I claim:

1. A method for post-sales customer retention comprising the steps of:
offering a plurality of merchants a centralized customer product information service, said customer product information service including access to a plurality of customer databases; and
providing access to said plurality of customer databases to customers of said plurality of merchants.

2. The method according to claim 1 wherein said plurality of customer databases include information pertaining to products purchased by said customers.

3. The method according to claim 2 wherein said information pertaining to said products purchased by said customers includes information pertaining to services purchased by said customers.

4. The method according to claim 3 wherein said centralized customer product information service enables said customers to track said products purchased by said customers from said plurality of merchants.

5. The method according to claim 4 wherein said centralized customer product information service enables said customers to track claims submitted by said customers relating to said products purchased by said customers from said plurality of merchants.

7. The method according to claim 3 wherein said information pertaining to said products purchased by said customers includes detailed product information.

8. The method according to claim 7 wherein said detailed product information includes product specifications.

9. The method according to claim 7 wherein said detailed product information includes product serial numbers.

10. The method according to claim 7 wherein said detailed product information includes warranty information.

11. The method according to claim 7 wherein said detailed product information includes purchase receipts purchase dates, frequently asked questions, installation tips and manufacturer contact information.

12. The method according to claim 3 wherein said information pertaining to said services purchased by said customers includes detailed services information.

13. The method according to claim 12 wherein said detailed services information includes appointment bookings for said services.

14. The method according to claim 12 wherein said detailed services information includes appointment repair tracking.

15. The method according to claim 12 wherein said detailed services information includes information pertaining to repair services associated with said products purchased by said customers from said plurality of merchants.

16. The method according to claim 12 wherein said detailed services information includes appointment troubleshooting and self-diagnosis tips.

17. A method for post-sales customer retention comprising the steps of:
providing customers access to view a portfolio of products purchased from a plurality of merchants; and
enabling said customers to manage, edit and modify said portfolio.

18. The method according to claim 17 wherein said portfolio is accessible from websites of said plurality of merchants.

19. The method according to claim 17 further comprising the step of providing said customers with a list of service providers for each product in said portfolio of products.

20. A method for post-sales customer retention comprising the steps of:
enabling merchants to customize contract catalogs, generate contract reports and provide customer support; and
enabling merchants to link to a portfolio of products purchased by a customer.
